(19) United States
(12) Patent Application Publication
(10) Pub. No.: US 2008/0293894 A1
(43) Pub. Date: Nov. 27, 2008

(54) METHOD OF IMPROVING THERMAL STABILITY OF POLY-3-HYDROXYBUTYRATE

(76) Inventors: Shinn-Gwo HONG, Taoyuan (TW); Yi-Ming Sun, Taoyuan (TW)

Correspondence Address: RABIN & Berdo, PC, 1101 14TH STREET, NW, SUITE 500, WASHINGTON, DC, 20005, US

(21) Appl. No.: 12/124,266

(22) Filed: May 21, 2008

(30) Foreign Application Priority Data
May 24, 2007 (TW) 096118486

(51) Int. Cl. C08G 63/02

(52) U.S. Cl. 525/450

(57) ABSTRACT

The present invention discloses a method of improving the thermal stability of poly-3-hydroxybutyrate (PHB). The thermal stability of PHB was improved by grafting maleic anhydride (MA) onto the PHB through various processes. It has been proved that purified grafted PHB had a higher degradation temperature, a better thermal stability than the pristine PHB, and was not easy to decrease molecular weight by heat treatment. At the same time, the crystallization rate, the melting temperature and crystallinity were all increased. The MA was effectively grafted onto PHB by processes of solution grafting, melt grafting, mechanical grafting methods and so on. The grafting degree of MA was changed with the increasing amounts of the initiator and MA. The degradation temperature of the PHB was significantly increased by MA grafting because the degradation was blocked in the formation of six-member ring by the steric hindrance of the grafted MA. The PHB grafted with the mechanical grafting method was not easy to generate scission degradation during reaction, and showed the best thermal stability and forming ability. The initial degradation temperature of PHB was increased at least 50° C.

### BACKGROUND OF THE INVENTION

1. Field of the Invention

The present invention relates to a method of improving the thermal stability, especially to a method of improving the thermal stability of poly-3-hydroxybutyrate (PHB).

2. The Prior Arts

Synthetic plastic materials become materials of daily uses since they are low in cost, various in characteristics and rapid in production. The disposal of synthetic plastics based on petrochemicals lead to increasingly serious environmental problems such as pollution and ecological impact because of their persistence to microbial degradation in nature environment, though they have advantages of convenience and low cost. Recently, legislation has restricted the uses of plastic bags made of polyethylene (PE), polypropylene (PP), polystyrene (PS), and polyvinylchloride (PVC) due to the rising tide of eco-awareness as well as the government initiatives, which is now toward low-contamination, recycling and energy saving. In addition, limited availability and high price of crude oil are other problems for the petrochemical industry. The studies of substitutes such as bio-compatible and biodegradable materials for petrochemical-based plastics to achieve sustainable management are therefore in urgent need.

Polyhydroxyalkanoates (PHAs) are polyesters produced by microorganisms. Hydroxyalkanoic acid are accumulated and converted to PHAs in microorganisms when they are grown under unbalanced nutritional conditions, for example, excess carbon source or lacking of other nutrients such as nitrogen, phosphate, sulfur, oxygen, or magnesium. Poly-3-hydroxybutyrate (PHB) is a PHA that was first isolated and characterized in 1926 from Bacillus megaterium. The function and properties of PHB were determined during 1980s, and PHB was produced commercially since then.

PHB displays a spiral crystalline structure having a molecular weight in the range of 1×10⁴˜3×10⁶ Da and a crystal density in the range of 1.23˜1.26 g/cm³. Young's modulus of PHB is roughly twice to that of PP. The tensile strength of PHB is close to that of PP. PHB, whose physical properties and thermal properties are similar to PP, exhibits a lower tolerance to solvent but a higher UV stability.

Plastics withstand stressful conditions like high temperatures and high shear stresses for injection molding or extrusion molding during industrial manufacturing processes. However, the difficulty in molding of PHB causes problems in application. The melting point of PHB is just slightly lower than the degrading temperature, this makes the melting processing by injection molding unstable. The molecular weights are decreased and the mechanical properties are affected when degradation of PHB occurs. Specifically, the mobility of molecule chains increases, degradation occurs via a six-member ring transition state, followed by random scission of ring chain and cleavage of C—C bond leading to shortening of the molecule chains, resulting in the decrease of molecular weight when PHB is melting. Therefore, the weight loss of PHB is not obvious under various conditions (air, nitrogen or vacuum) since the PHB is degraded through random chain scission but not radicals-transferring or oxidation. Studies through GC-MS showed that the short chain products of PHB degradation are unsaturated compounds crotonate and oligomers of PHB. The figure is shown below (Kunioka, M., Doi, Y., Macromolecules, 23, 1933 (1990).

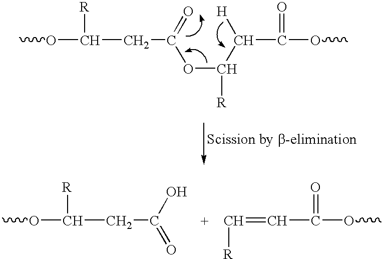

There was a direct correlation between PHA side chain length/types and rate of biodegradation. The degradation is not affected when having an alkyl side chain, whereas steric hindrance occurs to block the synthesis of ring transition structure and further decrease the rate of degradation when having an epoxy group or an unsaturated bond in a side chain. The crystalline and melting temperatures would be decreased during PHB degradation since the decrease of molecular weight caused the decrease of nucleus density, followed by a longer crystallization time. Part of the incomplete crystals would be melted first to lower the crystalline temperatures and melting points. The biggest problem during manufacturing process of PHB is the ease of degradation, which causes lower molecular weights and decreased mechanical properties. Therefore the important issues in PHB production are to overcome the degradation problem and to increase the degradation temperature.

At present, most of studies are focused on synthesizing PHB nano-composite materials, blending PHB with other polymers, grafting with methyl methacrylate, 2-hydroxyethyl methacrylate, acrylic acid or styrene, or inserting long side chain monomer to improve the thermal degradation properties of PHB. However, there are still many drawbacks to be overcome, such as complexity in manipulation steps. In addition, changing the unique biocompatibility and biodegradability of PHB are also problematic.

### SUMMARY OF THE INVENTION

The objective of the present invention is to provide a method for improving thermal stability of PHB, which effectively grafts maleic anhydrides (MA) onto PHB with processes including solution grafting, melt grafting, and mechanical grafting methods to solve the problem of poor thermal stability, wherein the mechanical grafting of the invention could be ball-milling grafting. At the same time the operation of the present invention is simple and the additives are quite few, both would not affect the unique biocompatibility and biodegradability of PHB.

Based on the abovementioned objective, the present invention discloses a method for improving thermal stability of PHB, which grafts maleic anhydrides (MA) onto PHB with various grafting processes. The thermal stability of PHB was improved by grafting maleic anhydride (MA) onto the PHB through various processes. It has been proved that purified grafted PHB had a higher degradation temperature, a better thermal stability than the pristine PHB, and was not easy to decrease molecular weight by heat treatment. At the same time, the crystallization rate, the melting temperature and crystallinity were all increased. The MA was effectively grafted onto PHB by processes of solution grafting, melt grafting, mechanical grafting and so on. The grafting degree of MA was changed with the increasing amounts of the initiator and MA. The degradation temperature of the PHB was significantly increased by MA grafting because the degradation was blocked by the steric hindrance of the grafted MA in the formation of six-member ring. The PHB grafted with the mechanical grafting method was not easy to generate scission degradation during reaction, and showed the best thermal stability and forming ability. The initial degradation temperature of PHB was increased at least 50° C.

The present invention is further explained in the following embodiment illustration and examples.

### BRIEF DESCRIPTION OF THE DRAWINGS

FIG. 1 is a DSC diagram of the present invention.

FIG. 2 is another DSC diagram of the present invention.

FIG. 3 is a TG-DTG diagram of the present invention.

### DETAILED DESCRIPTION OF THE PREFERRED EMBODIMENT

Grafting of MA onto PHB was carried out to improve the thermal stability of PHB with methods such as mechanical grafting, melt grafting, solution grafting and so forth in this invention. The mechanical grafting of the invention could be ball-milling grafting. Experiments of this invention showed that processes including mechanical grafting, melt grafting, and solution grafting could all increase the initial degradation temperature of PHB. Both the mechanical grafting and solution grafting methods with addition of 5 parts of MA showed significant results in increasing the initial degradation temperature of PHB to at least 50° C., while the melt grafting method only also showed a better result with the addition of 5 parts of MA. The products from mechanical grafting method did not generate scission degradation, which could form hot pressed films. However, the molecular weights of products from processes of melt grafting and solution grafting were decreased dramatically. They could not form hot pressed films and had poor forming ability during high temperature though the degradation temperatures were increased. On the other hand, the best superiority of the invention is that the PHB used does not need to be in high purity.

### Example 1

### Melt Grafting Method

(1) 50 g of PHB (purity 98%, average molecular weight 605000, dispersion rate 1.56) was added maleic anhydride (MA) and initiator benzoyl peroxide (BPO) in a different ratio (i.e. 5 Phr MA+1 Phr BPO) (phr: parts per hundred). The mixture was processed at 5 kg-m (100 rpm) for 10 min after preheated at 175° C. for 2 min in a Brabender PL2000 Plasticorder.

(2) The processed sample was ground and rinsed with acetone to wash out the un-reacted MA and initiators, then dried in a hood.

(3) The grafting degree of MA was 1.54% after reaction when analyzed with a GC.

(4) The grafting degree of MA was 1.44% after reaction when carried out in the ratio of 10 to 1 (10 Phr MA+1 Phr BPO) and analyzed with a GC.

### Example 2

### Solution Grafting Method

(1) 1 g of PHB was added 5 Phr of MA and one Phr of BPO dissolved in 20 ml of chloroform. The mixture was stirred at 55° C. for 6 hr in an oil bath.

(2) Fifteen ml of the processed sample was placed in a glass plate and the solvent was evaporated in a hood for 24 hr.

(3) Another 15 ml of the sample was added with 30 ml of methanol in drops through purification steps to recover PHB, which was washed with acetone several times and dried in a hood.

(4) The grafting degree of MA was 0.07% after reaction when analyzed with a GC.

### Example 3

### Mechanical Grafting Method

(1) 50 g of PHB was added MA and initiator BPO in different ratio (i.e. Phr MA+1 Phr BPO). The mixture was processed at 300 rpm for 10 hr in a Restch type 51 vibratory ball mill.

(2) The processed sample was rinsed with acetone several times to wash out the un-reacted MA and initiators, then dried in a hood.

(3) The grafting degree of MA was 0.12% after reaction when analyzed with a GC.

(4) The grafting degree of MA was 0.26% after reaction when carried out in the ratio of 10 to 1 (10 Phr MA+1 Phr BPO) and analyzed with a GC.

### A. DSC (Differential Scanning Calorimetry) Analysis of Grafted Samples

(1) The instrument system was purged with nitrogen at a flow rate of 40 ml/min and equilibrated for several min. 5-10 mg of samples were weighed and pressed into tablet in aluminum DSC pans.

(2) The temperature was increased from −40° C. to 185° C. at the rate of 10° C./min and stayed at 185° C. for 5 min to eliminate different heat history of each sample (1^{st} Heating Scan).

(3) The temperature was then set to decrease from 185° C. to −40° C. at the rate of 10° C./min and stayed at 40° C. for 2 min to crystallization desorption capacity and crystalline temperature of each sample (Cooling Scan).

(4) The temperature was increased again from −40° C. to 190° C. at the rate of 10° C./min to obtain melting heat absorption capacity and melting point of each sample (2^{nd} Heating Scan).

The results of DSC analysis:

| | DSC Scan | | | | | |
|---|---|---|---|---|---|---|
| | 1^{st} Heating Scan | | Cooling Scan | | 2^{nd} Heating Scan | |
| | Tm* | ΔHm^{#} | Tc | ΔHc | Tm | ΔHm |
| PHB Specimen | (° C.) | (J/g) | (° C.) | (J/g) | (° C.) | (J/g) |
| As-received | 170.8 | 81.5 | 41.6 | 30.4 | 122.9 | 48.9 |
| Melt-grafting | 169.3 | 92.8 | 105.3 | 80.0 | 166.4 | 93.6 |
| Solution-grafting | 171.4 | 101.8 | 91.6 | 74.1 | 167.7 | 91.0 |
| Mechanical- | 173.8 | 84.5 | 112.1 | 83.0 | 173.9 | 95.9 |
| grafting | | | | | | |

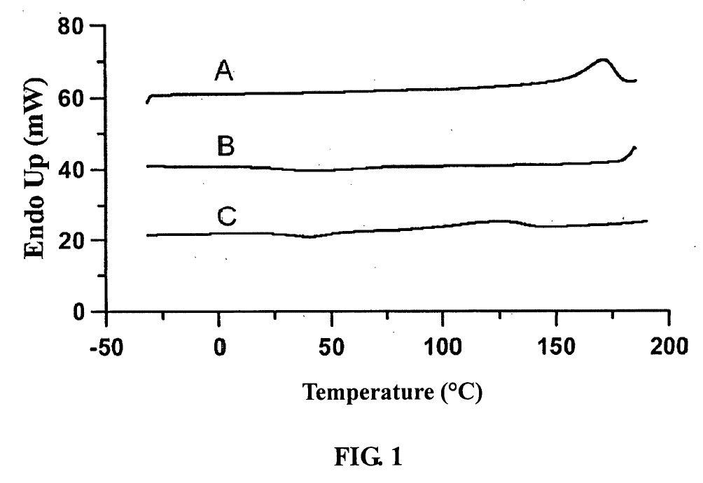

As shown in FIG. 1, curves A, B, C represent DSC analysis results of the first heating scan, cooling scan and the second heating scan, respectively.

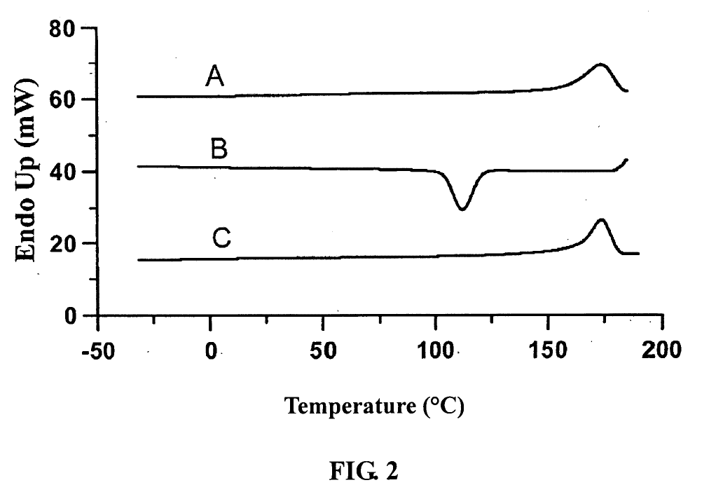

As shown in FIG. 2, curves A, B, C represent DSC analysis results of the first heating scan, cooling scan and the second heating scan, respectively.

### Summary of the DSC Analysis Results

a. Crystallization temperature of each sample was in the order of: mechanical grafting>melt grafting>solution grafting>>un-grafted sample (as-received).

b. Cooling crystallization size of each sample was in the order of: mechanical grafting>melt grafting>solution grafting>>un-grafted sample (as-received).

c. Cooling crystallization rate of each sample was in the order of: mechanical grafting>melt grafting>solution grafting>>un-grafted sample (as-received).

d. Melting point of each sample was in the order of: mechanical grafting>melt grafting>solution grafting>>un-grafted sample (as-received).

### B. Gel Permeation Chromatography (GPC) Analysis of Molecular Weight for Grafted Samples

(1) Samples weighed around 0.04 g were mixed with 5 ml of chloroform in a test tube and incubated in an oil bath with shaking (or sonication) for 1 hr and then for 8 hr without agitation.

(2) One liter of the chloroform was filtered through a 45 μm PTFE filter with suction and allowed to degas by sonicating for 30 min.

(3) Standards of known molecular weight were prepared in weight concentration of 1% to yield a standard curve.

(4) Samples were filtered through a 45 μm PTFE filter. An aliquot of sample (30 μl) was withdrawn with a 50 μl syringe and injected into the GPC system to yield GPC profile for MW determination through the standard curve.

The results of molecular weight analysis of GPC:

| | |
|---|---|
| | After DSC 1^{st} |
| As-prepared | Heating Scan |

| PHB Specimen | Mw | PDI | Mw | PDI |
|---|---|---|---|---|
| As-received | 605000 | 1.56 | 3878 | 1.76 |
| Melt-grafting | 62000 | 2.21 | 15930 | 2.31 |
| Solution-grafting | 252000 | 2.29 | 236000 | 3.45 |
| Mechanical-grafting | 458000 | 2.01 | 13890 | 1.89 |

Mw: average molecular weight.

### Summary of the GPC Analysis Results

a. The decrease of molecular weight of each sample after grafting was in the order of: melt grafting>solution grafting>mechanical grafting.

b. The decrease of molecular weight of each sample after DSC heating scan was in the order of: un-grafted sample (as-received)>mechanical grafting>melt grafting>solution grafting.

c. The molecular weights of samples after grafting were higher than that of un-grafted sample.

Thermogravimetric analysis (TGA) of PHB product

(1) The TGA system was purged with nitrogen at a flow rate of 40 ml/min.

(2) 5˜10 mg of samples were weighed and put into ceramic pans of TGA. The temperature was increased from 30° C. to 300° C. at the rate of 10° C./min to obtain the initial degradation temperature (Ti) and peak degradation temperature (Tp) of each sample.

The results of TGA analysis:

| | PHB Specimen | | | |
|---|---|---|---|---|
| | | | Solution- | Mechanical- |
| | As-received | Melt-grafting | grafting | grafting |
| Ti (° C.) | 189.8 | 236.4 | 237.7 | 243.4 |
| Tp (° C.) | 239.7 | 267.9 | 280.5 | 273.0 |

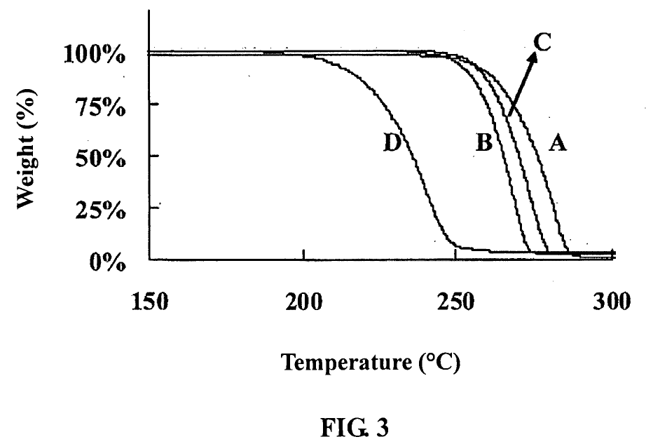

As shown in FIG. 3, curves A, B, C and D represent the temperature to weight % change of un-grafted sample (as-received), melt grafted sample, solution grafted sample and mechanical grafted sample respectively during TGA analysis.

### Summary of the TGA Analysis Results

a. The Ti of each sample was in the order of: mechanical grafting>melt grafting˜solution grafting>>un-grafted sample (as-received).

b. The Tp of each sample was in the order of: solution grafting>mechanical grafting>melt grafting>>un-grafted sample (as-received).

c. Thermal stabilities of all grafted samples were superior to that of un-grafted sample (as-received).

d. Degradation kinetics of PHB was affected by grafting MA.

e. The mechanical grafting method for MA grafting showed significant result in increasing initial degradation temperature of PHB to at least 50° C.

In summary, the present invention which discloses a method for improving thermal stability of PHB showed the following merits:

a. Improving methods of thermal stability of PHB can be applied in the biomaterial field;

b. The problem of poor thermal stability that PHB faced so far can be solved and the operation of the present invention is simple and the additives are quite few. In addition, the purity of PHB can be lower than 99%;

c. The problems such as complicated operation steps and changes of the unique biocompatibility and biodegradability of PHB can be solved.

The present invention disclosed above should not be limited by any of the above-described exemplary embodiments. These examples should not, however, be considered to limit the scope of the invention, it is contemplated that modifications will readily occur to those skilled in the art, which modifications will be within the spirit of the invention and the scope of the appended claims.

What is claimed is:

1. A method of improving the thermal stability of poly-3-hydroxybutyrate (PHB), which includes: adding grafting monomer and initiator, and processing by methods of solution grafting, melt grafting, and mechanical grafting to graft monomers onto PHB side chains to improve the thermal stability and thermal forming ability.

2. The method as claimed in claim 1, wherein the purity of PHB can be lower than 99%.

3. The method as claimed in claim 1, wherein the mechanical grafting is ball-milling grafting.

4. The method as claimed in claim 1, wherein the grafting monomer is a compound bearing unsaturated double bonds.

5. The method as claimed in claim 4, wherein the unsaturated double bonds bearing monomers are maleic anhydrides (MA).

6. The method as claimed in claim 1, wherein the initiator is a thermal free-radical initiator.

7. The method as claimed in claim 6, wherein the thermal free-radical initiator is benzoyl peroxide.

8. The method as claimed in claim 1, wherein PHB includes bio-polymers derived from poly-3-hydroxybutyrate.
